(19) United States
(12) Patent Application Publication
(10) Pub. No.: US 2025/0104423 A1
(43) Pub. Date: Mar. 27, 2025

(54) VIDEO PROCESSING METHOD AND DEVICE

(71) Applicant: Lemon Inc., Grand Cayman (KY)

(72) Inventors: Longyin WEN, Los Angeles, CA (US); Kai XU, Beijing (CN); Xiaohui SHEN, Los Angeles, CA (US)

(21) Appl. No.: 18/725,683

(22) PCT Filed: Dec. 27, 2022
(86) PCT No.: PCT/SG2022/050931

§ 371 Date: Jun. 28, 2024

(30) Foreign Application Priority Data
Dec. 28, 2021 (CN) 202111627991.2

(51) Int. Cl. G06V 20/40; G06V 10/26; G06V 10/764; G06V 10/77; G06V 10/82

(52) U.S. Cl. CPC G06V 20/41; G06V 10/26; G06V 10/764; G06V 10/7715; G06V 10/82; G06V 20/46

(57) ABSTRACT

Provided in the embodiments of the present disclosure are a video processing method and device. The video processing method includes: determining a target image to be processed in a video; performing semantic segmentation on the target image through a convolutional neural network to obtain a first feature map, wherein the first feature map comprises a feature map corresponding to at least one semantic class; determining a target image region corresponding to the at least one semantic class in the target image according to the first feature map; wherein the at least one semantic class comprises an object-in-hand, and a training image adopted by the convolutional neural network in a training process is marked with an image region corresponding to the at least one semantic class.

### CROSS-REFERENCE TO RELATED APPLICATION

The present application claims priority to Chinese Patent Application No. 202111627991.2 filed on Dec. 28, 2021, entitled “video processing method and device”, the entire content of which is incorporated herein by reference.

### TECHNICAL FIELD

The embodiment of the disclosure relates to the technical field of computer, in particular to a video processing method and device, an electronic device, a computer-readable storage medium, a computer program product and a computer program.

### BACKGROUND

With the development of science and technology, more and more video applications have emerged, such as short video software and live broadcast software. The appearance of these softwires enriches people's spare time. For example, people can record their lives by recording videos, taking photos and uploading them to short video software for sharing.

In video production, people are one of the most concerned main elements, and various Artificial Intelligence (AI) capabilities related to people (such as intelligent detection of objects) have been widely concerned. Among them, in many application scenarios (such as live broadcast and online teaching), a viewer pays special attention to an object held by a person in the video. Therefore, intelligent detection of the object held by the person in the video can be developed to design a series of interesting special effects, enrich the gameplay and improve the user experience.

However, at present, more attention is paid to the modeling of the hand itself but not to the object in the hand. Moreover, the object detector usually detects specific types of objects, which is not universal, and the types of objects held by the person in videos vary widely. Therefore, it is necessary to design a method to determine the image region where people hold any objects.

### SUMMARY

The embodiment of the disclosure provides a video processing method and device, an electronic device, a computer-readable storage medium, a computer program product, and a computer program, so as to solve the problem of how to determine the image region where a person holds any object.

In a first aspect, an embodiment of the present disclosure provides a video processing method, including:
determining a target image to be processed in a video;
performing semantic segmentation on the target image through a convolutional neural network to obtain a first feature map, wherein the first feature map comprises a feature map corresponding to at least one semantic class;
determining a target image region corresponding to the semantic class in the target image according to the first feature map;
wherein the semantic class comprises an object-in-hand and a training image adopted by the convolutional neural network in a training process is marked with an image region corresponding to the semantic class.

In a second aspect, an embodiment of the present disclosure provides a video processing device, including:
a first determination unit, configured for determining a target image to be processed in a video;
a segmentation unit, configured for performing semantic segmentation on the target image through a convolutional neural network to obtain a first feature map, wherein the first feature map comprises a feature map corresponding to at least one semantic class;
a second determination unit, configured for determining a target image region corresponding to the semantic class in the target image according to the first feature map;
wherein the semantic class comprises an object-in-hand and a training image adopted by the convolutional neural network in a training process is marked with an image region corresponding to the semantic class.

In a third aspect, an embodiment of the present disclosure provides an electronic device including at least one processor and a memory. Wherein, the memory stores computer-executed instructions; the at least one processor executes the computer-executed instructions stored in the memory, so that the at least one processor executes the video processing method as described in the first aspect or various possible designs of the first aspect above.

In a fourth aspect, an embodiment of the present disclosure provides a computer-readable storage medium in which computer-executable instructions are stored, and when the computer-executable instructions are executed by a processor, the video processing method described in the first aspect or various possible designs of the first aspect is realized.

In a fifth aspect, according to one or more embodiments of the present disclosure, a computer program product is provided, and the computer program product contains computer-executed instructions, and when a processor executes the computer-executed instructions, the video processing method described in the first aspect or various possible designs of the first aspect is realized.

In a sixth aspect, according to one or more embodiments of the present disclosure, a computer program is provided and, when executed by a processor, realizes the video processing method as described in the first aspect or various possible designs of the first aspect above.

According to the video processing method and device, electronic device, computer-readable storage medium, computer program product, and computer program provided by the embodiment of the present disclosure, objects held by the person are labeled as a semantic class, namely “objects-in-hand”. In the training process, a convolutional neural network is trained by using training images marked with image regions corresponding to semantic classes. In the application process, semantic segmentation on the image is to be processed in the video by the convolutional neural network to obtain the feature map. According to the feature map, the target image region corresponding to the semantic class in the image to be processed is determined. Therefore, the determination of the image region where the person holds any object in the video is realized, and the accuracy of object detection and tracking in the hand is improved.

### BRIEF DESCRIPTION OF DRAWINGS

In order to explain the embodiments of the present disclosure or the technical scheme in the prior art more clearly, the drawings needed in the description of the embodiments or the prior art will be briefly introduced below. Obviously, the drawings in the following description are some embodiments of the present disclosure, and other drawings can be obtained according to these drawings without creative labor.

FIG. 1 is an example diagram of an application scenario provided by an embodiment of the present disclosure;

FIG. 2 is a schematic flow diagram 1 of a video processing method provided by an embodiment of the present disclosure;

FIG. 3 is a schematic flow diagram 2 of the video processing method provided by the embodiment of the present disclosure;

FIG. 4 is an example diagram of object detection for an image in a video provided by an embodiment of the present disclosure;

FIG. 5 is a schematic flow diagram 3 of the video processing method provided by the embodiment of the present disclosure;

FIG. 6 is a structural example diagram of a convolutional neural network provided by an embodiment of the present disclosure;

FIG. 7 is a structural block diagram of a video processing device provided by an embodiment of the present disclosure;

FIG. 8 is a schematic diagram of the hardware structure of the electronic device provided by the embodiment of the present disclosure.

### DETAILED DESCRIPTION

In order to make the purpose, technical scheme and advantages of the embodiment of the disclosure more clear, the technical scheme in the embodiment of the disclosure will be described clearly and completely with the attached drawings. Obviously, the described embodiment is a part of the embodiment of the disclosure, but not the whole embodiment. Based on the embodiments in this disclosure, all other embodiments obtained by ordinary technicians in this field without creative work belong to the protection scope of this disclosure.

First, some words involved in the embodiment of the present disclosure are explained:

Semantic Segmentation: segmenting an object in the image according to the image semantic. Among them, the image semantic refers to the image content or the understanding of the image content. In the task of semantic segmentation, marking the image region where the object is located in the training image, and training the semantic segmentation model based on the training image. The semantic segmentation model classifies each pixel in the image to determine the image region where the object is located.

Optical flow: the size and direction of pixel motion of a spatially moving object on the imaging plane.

Next, the application scenario of the embodiment of the present disclosure is described:

The embodiment of the present disclosure may be applied to video real-time processing scenes or video off-line processing scenes. Among them, video real-time processing scenes may include, for example, the live video scene, the short video playback scene and the like. For example, in the live video scene, the object in the anchor's hand is detected.

Referring to FIG. 1, FIG. 1 is an example diagram of an application scenario provided by an embodiment of the present disclosure.

As shown in FIG. 1, taking a video real-time processing scene as an example, the device involved includes a terminal 101. In a real-time processing scenario, the terminal 101 may detect and/or track the object held by the person in the shot video while shooting the video; in another real-time processing scenario, the terminal 101 may detect and/or track the object held by the person in the played video while playing the video.

Optionally, the application scenario also involves the server 102. The server 102 detects and/or tracks the object held by the person in the video shot or played by the terminal. The server 102 communicates with the terminal 101 through a network, for example, to transmit video data, an object detection result, and the like.

The discovery process and inventive concept of the technical problems to be solved by the embodiment of the present disclosure are as follows:

The inventor found that in the related technology of target detection, the modeling of the hand itself is more considered, that is, the detection of the hand is considered, but the situation of the object held in the hand is not considered. When detecting an object-in-hand (i.e., an object held in a hand), the detector needs to be retrained. However, the method of training a detector to detect the object held by the person usually only deals with specific types of objects and is not universal. For example, through a large number of images marked with a cup held by the person, a detector for detecting the cup held by the person is trained. Because of the diversity and randomness of the objects held by the person, there is an urgent need for a method to detect any objects in their hands.

The inventor found that there is strong contextual information on the image of the object held by the person, that is, the object in contact with the hand. Therefore, the object held by a person in an image may be labeled as the same semantic class without classification limitation. Then, the semantic segmentation method of the image is used to detect the image region where any object in the hand of the person is located.

Based on this, the embodiment of the present disclosure provides a video processing method and device capable of detecting any object in the hand. In the embodiment of the present disclosure, an image region corresponding to at least one semantic class is marked on a training image, wherein at least one semantic class includes the object-in-hand. Training the convolutional neural network for image semantic segmentation by means of the training images. Therefore, when processing the video, the convolutional neural network may be used to semantically segment the image in the video, and determining the image region corresponding to the semantic class in the image in the video, so as to realize the detection of the image region where the object-in-hand is located.

It can be seen that, in the embodiment of the present disclosure, based on the idea of uniformly labeling any object in the hand as a semantic class “object-in-hand”, the detection of any object in the hand is realized by using the semantic segmentation method of the image, and the limitation of the category of the object-in-hand on the object detection in the hand is solved.

Subsequently, a plurality of embodiments of the present disclosure are provided.

It should be noted that the detection method of the object-in-hand provided by the embodiment of the present disclosure may also provide the underlying algorithm support for various special effects design and video editing based on the object-in-hand.

It should be noted that the embodiments of the present disclosure can be applied to electronic devices, such as the terminal or server.

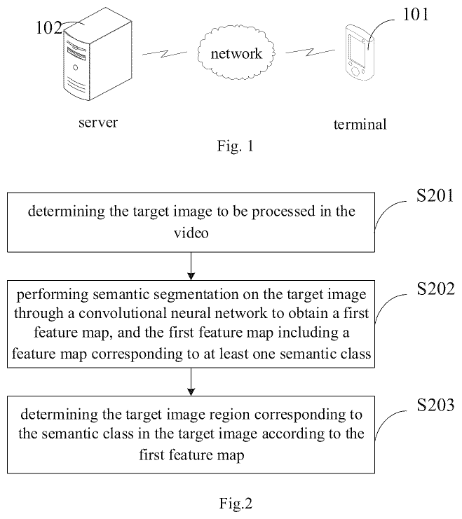

Referring to FIG. 2, FIG. 2 is a schematic flow diagram 1 of a video processing method provided by an embodiment of the present disclosure. As shown in FIG. 2, the video processing method includes:
S201, determining the target image to be processed in the video.

The video may be the video being played on the terminal, or the video shot by the camera in real time, or the video stored in the database. The target image is a video frame in which the object-in-hand is to be detected, and the number of the target images may be one or more.

In this embodiment, the target image may be obtained from the video according to the sequence of video frames in the video. For example, the first video frame without the detection of the object-in-hand in the video is obtained as the target image.
S202, performing semantic segmentation on the target image through a convolutional neural network to obtain a first feature map, and the first feature map including a feature map corresponding to at least one semantic class.

The convolutional neural network is a network model trained in advance based on the training image, and the training image is marked with an image region corresponding to at least one semantic class.

At least one semantic class includes an object-in-hand (that is, an object held in a hand). Convolutional neural network is used to detect the image region corresponding to the at least one semantic class in the image by semantic segmentation.

In this embodiment, the target image is input into the convolutional neural network, and the target image is down sampled and up sampled through the convolutional neural network to obtain the first feature map output by the convolutional neural network.

The size of the first feature map is the same as that of the target image, and the pixel value in the first feature map is used to indicate a weight that a pixel at the corresponding position in the target image belongs to the classification corresponding to the first feature map. Since the first feature map includes a feature map corresponding to at least one semantic class, and at least one semantic class includes the object-in-hand, the pixel value in a feature map corresponding to a semantic class of the object-in-hand is used to indicate the weight of the pixel at the corresponding position in the target image belonging to the object-in-hand, that is, the weight of the image region where the semantic class of the object-in-hand belongs.
S203, determining the target image region corresponding to the semantic class in the target image according to the first feature map.

In this embodiment, according to the pixel values in the first feature map, determining the classification to which each pixel in the target image belongs. Determining the classification of each pixel in the target image includes, determining the semantic class to which each pixel belongs, especially determining whether each pixel belongs to the semantic class of the object-in-hand. In this way, the classification results of pixels in the target image are obtained, and according to the classification results, the image region corresponding to the semantic class in the target image is determined. In order to facilitate the distinction, the image region corresponding to the semantic class is called the target image region herein. Because the semantic class includes the object-in-hand, the determination of the image region corresponding to the object-in-hand in the target image can be realized.

In one possible implementation, the pixel value in the feature map corresponding to the object-in-hand may be compared with a preset threshold. If the pixel value in the feature map corresponding to the object-in-hand is greater than the preset threshold, it is determined that the pixel corresponding to the pixel value in the target image belongs to the semantic class of the object-in-hand.

In another possible implementation, the pixel value in the feature map corresponding to the object-in-hand may be compared with the pixel value at the corresponding position in other feature maps in the first feature map. If the pixel value in the feature map corresponding to the object-in-hand is greater than the pixel value at the corresponding position in all other feature maps in the first feature map, it is determined that the pixel corresponding to the pixel value in the target image belongs to the semantic class of the object-in-hand.

In the embodiment of the present disclosure, based on a convolutional neural network, performing semantic segmentation on the target image in a video to obtain a first feature map including a feature map corresponding to a semantic class, and based on the first feature map, determining the target image region corresponding to the semantic class in the target image. The semantic class includes the object-in-hand. Therefore, by labeling any kind of object held by the person in the image as consistent semantic class “object-in-hand”, the detection of the image region where any object-in-hand is located in the image can be realized.

In some embodiments, the first feature map includes a first sub-feature map and a second sub-feature map, and the first sub-feature map corresponds to the image background in the first feature map and the second sub-feature map corresponds to the semantic class in the first feature map. The pixel value in the first sub-feature map indicates the weight that the pixel at the corresponding position in the target image belongs to the image background, and the pixel value in the second sub-feature map indicates the weight that the pixel at the corresponding position in the target image belongs to the semantic class corresponding to the second sub-feature map. Among them, when the number of semantic classes is multiple, the number of second sub-feature maps is also multiple, and different second sub-feature maps correspond to different semantic classes.

Based on the first feature map including the first sub-feature map and the second sub-feature map, in one possible implementation, the target image region corresponding to the semantic class in the target image may be determined according to the first sub-feature map and the second sub-feature map, so as to improve the accuracy of the target image region, that is, to improve the accuracy of detecting the image region where any object-in-hand is located.

In this implementation, when the first feature map includes a first sub-feature map corresponding to the image background and at least one second sub-feature map corresponding to at least one semantic class one by one, each pixel in the target image may be classified based on the first sub-feature map and at least one second sub-feature map, that is, determining whether each pixel in the target image belongs to the image background or a certain semantic class. According to the classification results of pixels in the target image, determining the image background and the target image region corresponding to the semantic class in the target image.

Optionally, in the process of classifying each pixel in the target image based on the first sub-feature map and the second sub-feature map, comparing the corresponding pixel value in the first sub-feature map with the corresponding pixel value in the second sub-feature map to determine the maximum value among the corresponding pixel values in the first sub-feature map and the second sub-feature map, the corresponding pixel value in the first sub-feature map and the corresponding pixel value in the second sub-feature map correspond to the same pixel in the target image. If the feature map where the maximum value is located is the first sub-feature map, it is determined that the pixel belongs to the image background, otherwise, it is determined that the pixel value belongs to the semantic class corresponding to the feature map where the maximum value is located. According to the semantic classes to which a plurality of pixels in the target image belong, determining the target image region.

For example, when classifying the pixel with the image position at (0,0) in the target image, if the pixel value at (0,0) in the first sub-feature map is greater than that at (0,0) in all the second sub-feature maps, it is determined that the pixel with the image position at (0,0) belongs to the image background, that is, it is located in the image background region of the target image. If the pixel value at (0,0) in the second sub-feature map corresponding to the object-in-hand is greater than that at (0,0) in the first sub-feature map and that at (0,0) in all other second sub-feature maps, it is determined that the pixel belongs to the object-in-hand, that is, it is located in the target image region corresponding to the semantic class of the object-in-hand.

In some embodiments, considering the small area of the object-in-hand and the small proportion in the image, in order to further enhance the contextual information, a plurality of semantic classes may be set, and contextual relations exist among different semantic classes, so as to improve the accuracy of detecting the image region where the object-in-hand is located.

Optionally, in addition to the objects in the hand, the semantic classes also include at least one of the following: hand and arm.

Furthermore, the semantic class of the arm includes at least one of the following: upper arm and forearm.

Taking the semantic classes including object-in-hand, hand, upper arm, and forearm as an example, in the first feature map, the first sub-feature map is the feature map corresponding to the image background, and the second sub-feature maps include the feature map corresponding to the object-in-hand, the feature map corresponding to the hand, the feature map corresponding to the upper arm, and the feature map corresponding to the forearm. According to the first sub-feature map and a plurality of second sub-feature maps, it is determined whether each pixel in the target image belongs to the image background or to which semantic classes. The specific determination process refers to the aforementioned embodiment. In this way, the image background region in the target image, the target image region corresponding to the object-in-hand, the target image region corresponding to the hand, the target image region corresponding to the upper arm, and the target image region corresponding to the forearm can be inspected.

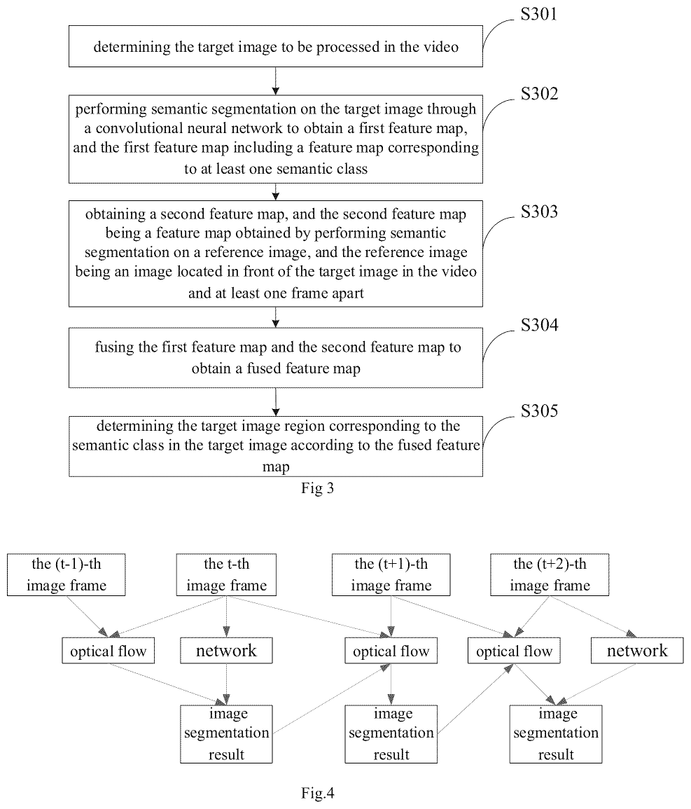

The video includes a plurality of image frames, and the image contents of different image frames are similar, especially the image contents between adjacent image frames are more similar. Therefore, another embodiment of the video processing method can be provided based on the idea of using the image segmentation results of other images in the video to assist the semantic segmentation of the current target image. Referring to FIG. 3, FIG. 3 is a schematic flow diagram 2 of the video processing method provided by the embodiment of the present disclosure. As shown in FIG. 3, the video processing method includes:
S301: determining the target image to be processed in the video.
S302: performing semantic segmentation on the target image through a convolutional neural network to obtain a first feature map, and the first feature map including a feature map corresponding to at least one semantic class.

The implementation principles and technical effects of S301-S302 can refer to the above-mentioned embodiments, and will not be described in detail.

S303: obtaining a second feature map, and the second feature map being a feature map obtained by performing semantic segmentation on a reference image, and the reference image being an image located in front of the target image in the video and at least one frame apart.

In this embodiment, when a plurality of frames of images in the video are semantically segmented in sequence through a convolutional neural network, a feature map finally obtained by semantically segmenting one or more images may be saved, and a second feature map may be obtained from the saved feature maps. Taking the reference image is a previous image frame of the target image in the video as an example, after performing semantic segmentation on the previous image frame by the convolutional neural network, obtaining and saving the feature maps (equivalent to the first feature map of the target image) of the previous image frame, and in the process of detecting the object-in-hand in the target image, obtaining the feature maps of the previous image frame as the second feature map.
S304: fusing the first feature map and the second feature map to obtain a fused feature map.

In this embodiment, the first feature map includes a feature map corresponding to at least one semantic class, and the second feature map also includes a feature map corresponding to at least one semantic class. Therefore, the feature map corresponding to one semantic class in the first feature map and the feature map corresponding to the one semantic class in the second feature map may be fused to obtain the fused feature map corresponding to the one semantic class. In this way, obtaining the fused feature map corresponding to at least one semantic class. In particular, fusing the feature map corresponding to the object-in-hand in the first feature map with the feature map corresponding to the object-in-hand in the second feature map to obtain the fused feature map corresponding to the object-in-hand.

In an example, in the process of fusing the feature map corresponding to a semantic class in the first feature map and the feature map corresponding to the semantic class in the second feature map, the pixel value in the feature map corresponding to the semantic class in the first feature map and the pixel value at the corresponding position in the feature map corresponding to the semantic class in the second feature map may be summed or averaged to obtain the pixel value at the corresponding position in the fused feature map.
S305: determining the target image region corresponding to the semantic class in the target image according to the fused feature map.

In this embodiment, after obtaining the fused feature map, a pixel value in a fused feature map corresponding to a certain semantic class reflects a weight of a pixel at a corresponding position in the target image belonging to the semantic class. Therefore, according to the pixel values in the fused feature map, determining the semantic class of each pixel in the target image to obtain the target image region corresponding to the semantic class in the target image. In particular, determining a plurality of pixels belonging to the object-in-hand in the target image and obtaining the target image region corresponding to the object-in-hand in the target image according to the position distribution of the plurality of pixels in the target image.

In the embodiment of the present disclosure, on the basis of realizing the detection of any object-in-hand in the image by using the semantic segmentation of the image, the feature map of the reference image located in front of the target image in the video is used to assist the detection of the object-in-hand in the target image. Compared with the detection of the object-in-hand in the target image only based on the image features contained in the target image itself, the accuracy of the detection of the object-in-hand in the target image is effectively improved.

In some embodiments, when both the first feature map and the second feature map both includes feature maps corresponding to the image background, the feature map corresponding to the image background in the first feature map and the feature map corresponding to the image background in the second feature map may be fused to obtain a first fused sub-feature map; the feature map corresponding to a semantic class in the first feature map and a feature map corresponding to the same semantic class in the second feature map are fused to obtain a second fused sub-feature map. According to the first fused sub-feature map and the second fused sub-feature map, the target image region corresponding to the semantic class in the target image is determined.

In this embodiment, the first fused sub-feature map corresponds to the image background, and the second fused sub-feature map corresponds to the semantic class. When a plurality of semantic classes are provided, different second fused sub-feature maps correspond to different semantic classes. After obtaining the first fused sub-feature map and the second fused sub-feature maps, for each pixel in the target image, determining the maximum value among the pixel values corresponding to the pixel in the first fused sub-feature map and the second fused sub-feature map; if the maximum value is the pixel value in the first fused sub-feature map, determining that the pixel belongs to the image background; otherwise, determining a semantic class of the feature map where the maximum value is located, and determining that the pixel belongs to the semantic class. In this way, obtaining the classification of each pixel in the target image, especially the pixel belonging to the object-in-hand in the target image, and obtaining the target image region corresponding to the object-in-hand in the target image.

In some embodiments, before fusing the first feature map and the second feature map to obtain the fused feature map, determining an optical flow between the target image and the reference image, and adjusting the second feature map according to the optical flow. Then, the first feature map and the adjusted second feature map are fused.

In this embodiment, in actual situations, due to the movement of objects (such as the camera and the person in the video), there is a slight pixel shift between images of different frames in the video, which leads to jitter in image segmentation results. In order to reduce the influence of pixel movement between images on the accuracy of hand object detection in the target image, improve the stability of image semantic segmentation, and improve the continuity of image segmentation results of different frames of images, the second feature map is adjusted through the optical flow between the target image and the reference image.

The optical flow between the target image and the reference image may be randomly determined, or the optical flow between the target image and the reference image may also be extracted by determining the change of pixels in the target image and the reference image, and the extraction process of the optical flow is not limited here.

Adjusting the second feature map based on optical flow means adjusting the pixel values in the second feature map based on optical flow, that is, adjusting the pixel values in the second feature map up or down based on optical flow.

In some embodiments, the target image is determined in the video according to a preset number of frames at intervals. In other words, the image in the video is semantically segmented every certain number of frames, instead of semantically segmenting every frame in the video, which improves the efficiency of hand object detection in the video.

Optionally, in the video, for the image to be processed without using a convolutional neural network for semantic segmentation, the image segmentation result of the previous frame of the image of the image to be processed in the video may be obtained, and based on the image segmentation result of the previous frame of the image, the image region corresponding to the semantic class in the image to be processed may be determined.

Further, the image segmentation result of the previous image frame may be adjusted based on the optical flow between the previous image frame and the image to be processed, and the image region corresponding to the semantic class in the image to be processed may be determined according to the adjusted image segmentation result. Among them, the image segmentation result of the previous image frame may include the feature maps of the previous image frame, which may be obtained by performing semantic segmentation on the previous image frame through the convolutional neural network, or may be obtained based on the image segmentation result of the image located before the previous image frame in the video when detecting the object-in-hand in the previous image frame.

In this alternative, the feature maps of the previous image frame may be adjusted based on the optical flow between the previous image frame and the image to be processed, and the feature maps of the image to be processed may be determined as the adjusted feature maps of the previous image frame. Then, based on the feature maps of the image to be processed, the image region corresponding to the semantic class in the image to be processed is determined. Among them, the feature maps in this alternative mode can refer to the first feature map in the previous embodiment.

Taking the interval frame number being 1 as an example, referring to FIG. 4, which is an example diagram of object detection for an image in a video provided by an embodiment of the present disclosure. As shown in FIG. 4, the convolutional neural network is used every other frame: the t-th image frame is semantically segmented by the convolutional neural network, the t+1-th image frame is not semantically segmented with convolutional neural network, and the t+2-th image frame is semantically segmented by the convolutional neural network.

In FIG. 4, when processing the t-th image frame, performing semantic segmentation on the t-th image frame to obtain the image segmentation result based on the convolutional neural network, and obtaining the image segmentation result of the t−1-th image frame propagated by optical flow (the image processing result of the t−1-th image frame is adjusted based on the optical flow between the t−1-th image frame and the t-th image frame), and obtaining the final image segmentation result of the t-th image frame by combining the image segmentation result of the t-th image frame obtained by convolution neural network with the propagated image segmentation result of the t−1-th image frame. The image segmentation result of the t+1-th image frame may directly adopt the image segmentation result of the t-th image frame propagated by optical flow. Among them, propagation by optical flow means the adjustment based on optical flow.

In some embodiments, performing semantic segmentation on a target image through the convolutional neural network to obtain the first feature map, may include: performing semantic segmentation on the target image and a preset number of images in the video located in front of the target image through the convolutional neural network to obtain the first feature map, and the preset number of images located in front of the target image being used for assisting the semantic segmentation of the target image. Therefore, when the image in the video is semantically segmented, not only the image features reflected by the image content but also the spatial-temporal features reflected by the images in the video are used, which effectively improves the accuracy of the semantic segmentation of the image.

In this embodiment, before performing semantic segmentation on the target image, a preset number of images located in front of the target image are obtained from the video, the target image and the preset number of images are input into the convolutional neural network, and the target image and the preset number of images are semantically segmented by the convolutional neural network to obtain the first feature map output by the convolutional neural network. At this time, the convolutional neural network is a video semantic segmentation network, which can make full use of video information, extract temporal and spatial features by mining the time sequence consistency information in the video, and realize the semantic segmentation of the target image by combining temporal and spatial features and image features. Similar to the effect of introducing optical flow to improve the stability of semantic segmentation in the previous embodiment, this embodiment improves the stability of semantic segmentation by introducing multiple images in front of the target image, thus improving accuracy.

The video includes a plurality of image frames. Based on the image region corresponding to the semantic class in the image, the tracking of object corresponding to the semantic class may be realized. Therefore, another embodiment of the video processing method is provided based on tracking the object corresponding to the semantic class. Referring to FIG. 5, FIG. 5 is a schematic flow diagram 3 of the video processing method provided by the embodiment of the present disclosure. As shown in FIG. 5, the video processing method includes:
S501: determining a target image to be processed in the video.
S502: performing semantic segmentation on the target image through a convolutional neural network to obtain a first feature map, and the first feature map including a feature map corresponding to at least one semantic class.
S503: determining a target image region corresponding to the semantic class in the target image according to the first feature map.

Among them, the implementation principles and technical effects of S501˜S503 can refer to the previous embodiments, and will not be repeated here.
S504: generating a target box corresponding to the object-in-hand in the target image according to the target image region.

Among them, a target image region may correspond to a target box, different target image regions correspond to different target boxes, and different objects-in-hand correspond to different target boxes. For example, if the semantic classifications include hand, object-in-hand, upper arm, and forearm, if the target image regions corresponding to the hand, the object-in-hand, the upper arm, and the forearm are detected in the target image, the target image regions corresponding to the hand, the object-in-hand, the upper arm and the forearm are labeled with different target boxes.

In this embodiment, in the target image, a target box including the target image region is generated based on the target image region corresponding to the object-in-hand. If a plurality of target image regions corresponding to the object-in-hand are provided, for each target image region, a target box including the target image region is generated.

Optionally, the target box corresponding to the object-in-hand is a Bounding Rectangle or a Minimum Bounding Rectangle, MBR) of the target image region corresponding to the object-in-hand, so that the target box can accurately contain (or cover) the target image region corresponding to the object-in-hand through the bounding rectangle or the minimum bounding rectangle.
S505, tracking the object-in-hand appearing in the target image according to the target box.

In this embodiment, after obtaining the target box corresponding to the object-in-hand in the target image, determining a tracking box corresponding to the object-in-hand based on the target box corresponding to the object-in-hand, and tracking the object-in-hand appearing in the target image according to the tracking box corresponding to the object-in-hand.

In an example, if the number of object-in-hand appearing in the video is less than or equal to 1, directly determining that the target box corresponding to the object-in-hand in the target image as the tracking box.

In another example, when a plurality of objects-in-hand are provided in the video, each object-in-hand in the video may be assigned with an object identifier. In order to ensure that the object identifier of the same object in the video are consistent, a multi-target tracking mode can be adopted to determine the tracking box in the video image.

In the multi-target tracking mode, a possible implementation of S505 includes: acquiring a tracking box, wherein the tracking box comes from the previous image frame of the target image, and different tracking boxes correspond to different object IDs, and the object ID is used to uniquely identify the object-in-hand; matching the tracking box with the target box to obtain a matching result; according to the matching result, updating the tracking box in the target image. Therefore, by updating the tracking box and the object ID corresponding to the tracking box, the tracking of multiple targets (i.e., multiple objects-in-hand) in the video is realized.

In this implementation, obtaining the tracking box (also called historical tracking box) in the previous image frame of the target image and the object ID corresponding to the tracking box. Because there are many objects in the video, the number of tracking boxes may also be multiple, and the number of target boxes may also be multiple, multiple tracking boxes and multiple target boxes may be matched in pairs to get the matching result.

Optionally, the following operations may be performed on the target image according to the matching result: if there is a tracking box matching with the target box, updating the tracking box matching with the target box to the target box; if there is no tracking box matching with the target box, determining the target box to be a new tracking box, and assigning an object ID to the new tracking box: if there is no target box matching with the tracking box, deleting the tracking box.

In this alternative, if there is a tracking box matching with the target box among a plurality of tracking boxes, it is determined that the tracking box matching with the target box is the tracking box of the object-in-hand corresponding to the target box, and the tracking box of the object-in-hand corresponding to the target box may be updated to the target box in the target image. The updating operation includes determining the target box as a tracking box in the target image and determining the object ID corresponding to the tracking box as the object ID corresponding to the tracking box matching the target box. If there is no tracking box matching the target box among the multiple tracking boxes, it means that the object-in-hand corresponding to the target box may be a new object-in-hand, so the target box may be determined as a new tracking box in the target image, and the unique object ID is assigned to the new tracking box to uniquely identify the object-in-hand in the new tracking box. If there is no target box matching with the tracking box among the multiple target boxes, it means that the object-in-hand corresponding to the tracking box may not appear in the target image, so the tracking box that fails to find a matching target box among multiple target boxes may be deleted.

Optionally, matching the tracking box with the target box to obtain a matching result, may include: determining an overlapping degree of the tracking box and the target box; according to the overlapping degree, determining the tracking box matching with the target box.

In this alternative mode, determining a tracking box matching with a target box by greedy algorithm based on the overlapping degree between the tracking box and the target box: for each target box, determining the tracking box with the largest overlapping degree with the target box as the tracking box matching with the target box; or, for each target box, it is determined that the tracking box with the largest overlapping degree with the target box and the overlapping degree is greater than a preset threshold is the tracking box that matches with the target box.

In this alternative, the overlapping degree between the tracking box and the target box may be determined by determining the Euclidean distance between the center point of the tracking box and the center point of the target box, wherein the smaller the Euclidean distance, the greater the overlapping degree between the tracking box and the target box. Therefore, for each tracking box, the tracking box with the smallest Euclidean distance between the center point of the tracking box and the center point of the target box is determined as the tracking box that matches with the target box: or, for each tracking box, it is determined that the tracking box with the smallest Euclidean distance between the center point of the tracking box and the center point of the target box and the Euclidean distance less than the preset threshold is the tracking box that matches with the target box.

In the embodiment of the present disclosure, any object-in-hand is detected in the image in the video by using the semantic segmentation of the image to obtain the image region corresponding to the object-in-hand in the image, and generating the target box corresponding to the object-in-hand in the image based on the image region corresponding to the object-in-hand, and then tracking the object-in-hand based on the target box corresponding to the object-in-hand. Therefore, not only the detection of any object in the hand in the video image is realized, but also the tracking of any object in the hand in the video is realized.

In addition to tracking the object-in-hand in the video, the object that the person throws out of their hands in the video may be tracked based on the corresponding image region of the object-in-hand in the image of the video.

In some embodiments, if there is a target object leaving the hand in the video, the target object is tracked based on the image region where the target object is located in the target image region.

In this embodiment, considering that after the target object is thrown out, the object leaves the hand and the semantic information of the object-in-hand may be lost, and the object cannot be segmented by using the semantic segmentation method provided in the previous embodiment, the target object leaving the hand may be tracked and segmented based on the image region where the target object was before it left the hand, or based on the corresponding target box or tracking box before it left the hand.

Optionally, the online representation learning method is adopted to track and segment the target object leaving the hand in the video. That is, using video target tracking or segmentation method, the target object leaving the hand in the video is tracked and segmented. For example, the video object tracking or segmentation method is the Siamese Mask method.

Optionally, after obtaining the target image region corresponding to the object-in-hand in the target image, it can be determined whether there is a target object leaving the hand according to the target image region corresponding to the object-in-hand in the target image and the target image region corresponding to the object-in-hand in the next image frame of the target image in the video.

For example, if the target image region corresponding to the object-in-hand does not appear in the next image frame, or if the number of target image regions corresponding to the objects-in-hand in the next image frame is less than the number of target image regions corresponding to the objects-in-hand in the target image, it is determined that there is a target object leaving the hand.

Next, the structure of the convolutional neural network related to the embodiment of the present disclosure will be described.

In some embodiments, the convolutional neural network includes a feature extraction network and a decoding network. The feature extraction network includes a plurality of convolution layers, and in the convolution layers, the feature extraction of the target image is realized by down-sampling the target image input into the convolutional neural network: the decoding network includes a plurality of convolution layers, in which the feature map from the feature extraction network is convolved and up-sampled, and finally the first feature map of the target image is obtained.

Optionally, the convolutional neural network adopts U-Net structure. In the U-Net network structure, the feature map output by the convolution layer in the feature extraction network and the feature map output by the convolution layer with the same feature scale in the decoding network are input to the next convolution layer in the decoding network. In other words, in the decoding network, the input data of the convolution layer includes the feature map output by the previous convolution layer and the feature map output by the convolution layer with the same feature scale in the feature extraction network.

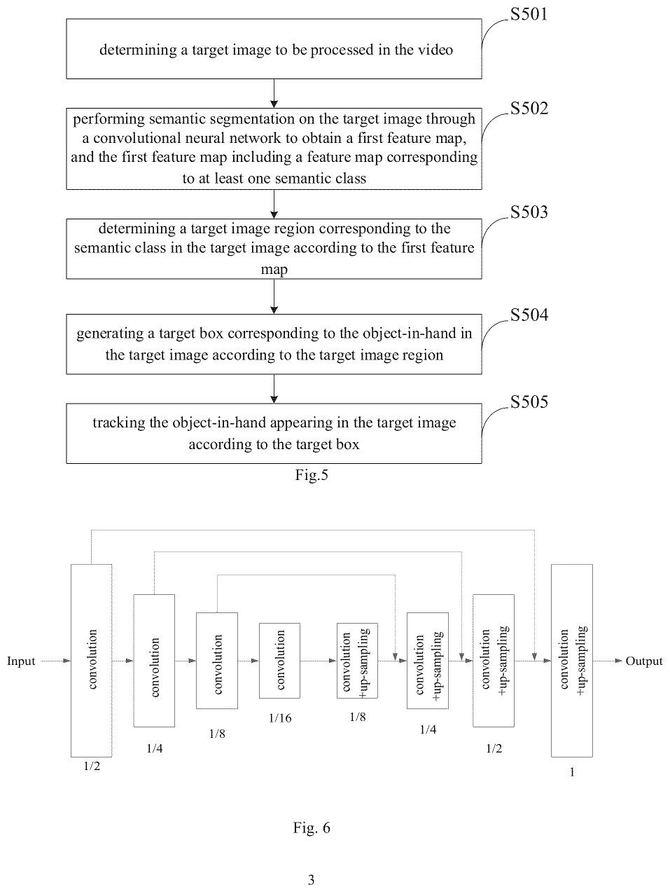

As an example, refer to FIG. 6, which is a structural example diagram of a convolutional neural network provided by an embodiment of the present disclosure. As shown in FIG. 6, the first half of a convolutional neural network is a feature extraction network, and the second half is a decoding network. In the feature extraction network, there are four convolution modules, and each convolution module MAY include one or more convolution layers. As the depth of the network increases, the feature scale of the convolution module (that is, the size of the feature map output by the convolution module) decreases by ½ in turn (as shown in FIG. 6, it is ½, ¼, ⅛ and 1/16 in turn). In the decoding network, there are four decoding modules, each of which includes convolution network and up-sampling. Except for the first decoding module, the input data of the decoding module includes the feature map output by the previous decoding module and the feature map output by the convolution module with the same feature size as the previous decoding module in the feature extraction network. Among them, with the increase of network depth, the feature scale of the decoding module (that is, the size of the feature map output by the convolution module) increases by ½ in turn (as shown in FIG. 6, it is ⅛, ¼, ½ and 1 in turn).

Optionally, the feature extraction network may adopt a lightweight network to improve the efficiency of feature extraction, thereby improving the detection efficiency of the object-in-hand in the video, and meeting the requirements of real-time detection of shooting or playing videos on lightweight devices. Among them, the feature extraction network can adopt a Residual Neural Network (ResNet) or GhostNet.

Alternatively, network structure search, network pruning, network quantization and other technologies may be used to reduce the model scale of convolutional neural network and make convolutional neural network lighter.

In this alternative, before training the convolutional neural network, the network structure of the feature extraction network in the convolutional neural network may be searched by the network structure search technology, and a lighter feature extraction network may be obtained. In the training process, network pruning is used to cut the number of network channels of convolutional neural network. After the training is completed, the network parameters of convolutional neural network are quantized.

Optionally, in the process of training the convolutional neural network, the data of the training images are augmented to increase the number and richness of the training images, thus improving the model effect of the convolutional neural network.

The processing operations of data augmentation include at least one of the following: image scaling, image rotation, image brightness transformation, image contrast transformation and image cropping.

Optionally, in the training process, Cross Entropy loss function is used to determine the loss value of convolutional neural network, and the parameters of convolutional neural network are optimized based on the loss value, optimization algorithm and preset learning rate, so as to improve the model effect of convolutional neural network.

Optionally, in the training process, a stochastic gradient descent (SGD) optimizer is used to optimize the network parameters of the convolutional neural network.

It should be noted that the process of applying a convolutional neural network to video processing and the training process of a convolutional neural network can be carried out on the same device or on different devices.

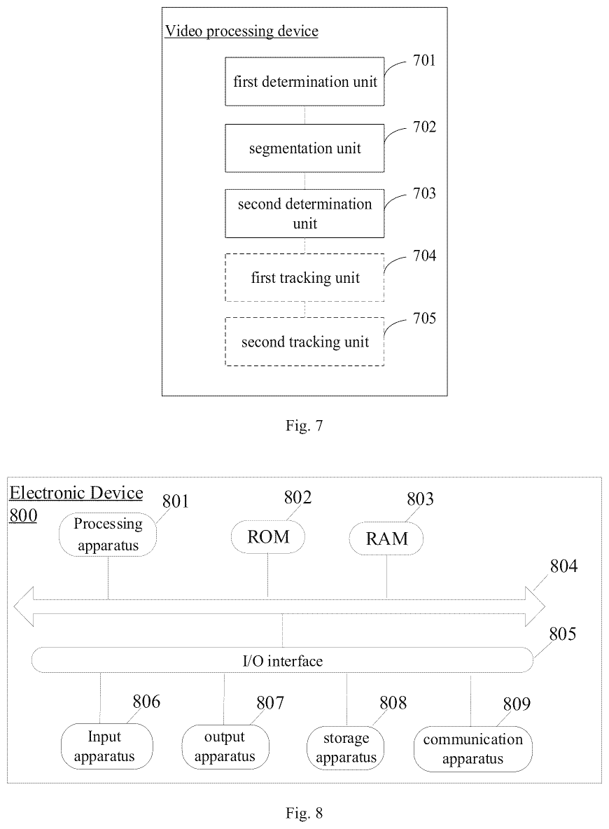

Corresponding to the video processing method of the above embodiment, FIG. 7 is a structural block diagram of the video processing device provided by the embodiment of the present disclosure. For convenience of explanation, only parts related to the embodiment of the present disclosure are shown. Referring to FIG. 7, the video processing device includes a first determination unit 701, a segmentation unit 702, and a second determination unit 703.

The first determination unit 701 is configured to determine a target image to be processed in a video.

The segmentation unit 702 is configured to perform semantic segmentation on the target image through a convolutional neural network to obtain a first feature map, wherein the first feature map includes a feature map corresponding to at least one semantic class.

The second determination unit 703 is configured to determine the target image region corresponding to at least one semantic class in the target image according to the first feature map.

Among them, at least one semantic class includes an object-in-hand, and the training image used by the convolutional neural network in the training process is marked with an image region corresponding to the semantic class.

In some embodiments, a plurality of semantic classes are provided, and there are contextual relations between different semantic classes.

At this time, the second determination unit 703 is further configured to determine the target image region according to the first sub-feature map and a plurality of second sub-feature maps; the first sub-feature map is a feature map corresponding to an image background in the first feature map, the second sub-feature map is a feature map corresponding to the semantic class in the first feature map, and different second sub-feature maps correspond to different semantic classes.

In some embodiments, a pixel value in the second sub-feature map is a weight that a corresponding pixel in the target image belongs to a semantic class corresponding to the second sub-feature map.

At this time, the second determination unit 703 is further configured to: for a plurality of pixels in the target image, determine a maximum value of the pixel among corresponding pixel values in the first sub-feature map and the second sub-feature map, if a feature map where the maximum value is located is the first sub-feature map, determine that the pixel belongs to the image background, otherwise, determine that the pixel belongs to a semantic class corresponding to the feature map where the maximum value is located; determine the target image region according to the semantic class to which the plurality of pixels belong.

In some embodiments, the second determination unit 703 is further configured to: acquire a second feature map, wherein the second feature map is a feature map obtained by performing semantic segmentation on a reference image, and the reference image is an image located in front of the target image in the video and at least one frame apart; fuse the first feature map and the second feature map to obtain a fused feature map; determine the target image region according to the fused feature map.

In some embodiments, the second determination unit 703 is further configured to fuse a feature map corresponding to an image background in the first feature map and a feature map corresponding to the image background in the second feature map to obtain a first fused sub-feature map; fuse a feature map corresponding to a semantic class in the first feature map with a feature map corresponding to a same semantic class in the second feature map to obtain a second fused sub-feature map.

In some embodiments, the second determination unit 703 is further configured to determine an optical flow between the target image and the reference image; adjust the second feature map according to the optical flow.

In some embodiments, the first determination unit 701 is further configured to determine the target image in the video according to a preset interval frame number.

In some embodiments, the video processing device further comprises a first tracking unit 704, the first tracking unit 704 is used for generating a target box corresponding to the object-in-hand in the target image according to the target image region; tracking the object-in-hand appearing in the target image according to the target box.

In some embodiments, the first tracking unit 704 is further configured to: acquire a tracking box, wherein the tracking box is from a previous image frame of the target image, different tracking boxes correspond to different object IDs, and the object ID is used for uniquely identifying the object-in-hand; match the tracking box with the target box to obtain a matching result: update the tracking box in the target image according to the matching result.

In some embodiments, the first tracking unit 704 is further configured to update the tracking box matching the target box to the target box if there is a tracking box matching the target box; if there is no tracking box matching the target box, determining that the target box is a new tracking box, and assigning the object ID to the new tracking box: if there is no target box matching the tracking box, deleting the tracking box.

In some embodiments, the first tracking unit 704 is further configured to determine an overlapping degree between the tracking box and the target box; determine a tracking box matched with the target box according to the overlapping degree.

In some embodiments, the video processing device further comprises a second tracking unit 705, the second tracking unit 705 is used for tracking the target object based on the image region where the target object is located on the target image region if the target object leaving the hand appears in the video.

In some embodiments, the segmentation unit 702 is further configured to perform semantic segmentation on the target image and a preset number of images in the video located in front of the target image through the convolutional neural network to obtain the first feature map, wherein the preset number of images located in front of the target image are used for assisting the semantic segmentation of the target image.

The video processing device provided in this embodiment can be used to implement the technical scheme of the embodiment of the above video processing method, and its implementation principle and technical effect are similar, so the details of this embodiment are not repeated here.

FIG. 8 is a structural schematic diagram of an electronic device 800 provided by an embodiment of the present disclosure, the electronic device 800 may be a terminal device or a server. The terminal devices in the embodiments of the present disclosure may include, but not limited to, mobile terminals such as a mobile phone, a notebook computer, a digital broadcast receiver, a personal digital assistant (PDA), a tablet computer (PAD), a portable multimedia player (PMP), a vehicle-mounted terminal (for example, a vehicle-mounted navigation terminal) and the like, and fixed terminals such as a digital TV, a desktop computer and the like. The electronic device shown in FIG. 8 is only an example and should not bring any limitation to the functions and application scope of the embodiments of the present disclosure.

As shown in FIG. 8, the electronic device 800 may include a processing apparatus (for example, a central processing unit, a graphics processing unit, etc.) 801, which may perform various appropriate actions and processes according to programs stored in a read-only memory (ROM) 802 or programs loaded from a storage apparatus 808 into a random-access memory (RAM) 803. In the RAM 803, various programs and data required for operations of the electronic device 800 are also stored. The processing apparatus 801, the ROM 802 and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touch pad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 may allow the electronic device 800 to perform wireless or wired communication with other devices to exchange data. While the electronic device 800 with various apparatuses is shown in FIG. 8, it should be understood that it is not required to implement or have all the apparatuses shown. More or fewer apparatuses may alternatively be implemented or provided.

According to the embodiments of the present disclosure, processes described above with reference to the flowchart may be implemented as a computer software program. For example, an embodiment of the present disclosure includes a computer program product, which includes a computer program carried on a non-transitory computer-readable medium, the computer program including program codes for performing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the above functions defined in the method of the embodiment of the present disclosure are performed.

It should be noted that the computer-readable medium mentioned above in the present disclosure may be a computer-readable signal medium or a computer-readable storage medium or any combination of both. The computer-readable storage medium may be, for example, but not limited to, an electrical, magnetic, optical, electromagnetic, infrared, or semiconductor system, apparatus or device, or a combination of any of the above. More specific examples of the computer-readable storage medium may include, but not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program, which program may be used by or in combination with an instruction execution system, apparatus or device. In the present disclosure, the computer-readable signal medium may include a data signal propagated in a baseband or as part of a carrier wave, in which computer-readable program codes are carried. This propagated data signal may take multiple forms, including but not limited to electromagnetic signals, optical signals or any suitable combination of the above. The computer-readable signal medium may also be any computer-readable medium other than the computer-readable storage medium and may send, propagate, or transmit a program used by or in combination with an instruction execution system, apparatus, or device. The program codes contained in the computer-readable medium may be transmitted by any suitable medium, including but not limited to: electric wires, optical cables, radio frequency (RF), and the like, or any suitable combination of the above.

The computer-readable medium may be included in the electronic device, or it may exist alone without being assembled into the electronic device.

The computer-readable medium carries one or more programs, which, when executed by the electronic device, cause the electronic device to perform the method shown in the above embodiments.

Computer program codes for performing the operations of the present disclosure may be written in one or more programming languages or combinations thereof, including but not limited to object-oriented programming languages such as Java, Smalltalk, and C++, and conventional procedural programming languages such as “C” or similar programming languages. The program codes may be completely executed on a user computer, partially executed on the user computer, executed as an independent software package, partially executed on the user computer and partially executed on a remote computer, or completely executed on the remote computer or a server. In the case involving the remote computer, the remote computer may be connected to the user computer through any type of network, including a local area network (LAN) or a wide area network (WAN), or may be connected to an external computer (for example, through the Internet using an Internet service provider).

The flowchart and block diagrams in the drawings illustrate architectures, functions, and operations of possible implementations of the systems, methods and the computer program product according to various embodiments of the present disclosure. In this regard, each block in the flowchart or block diagram may represent a part of a module, a program segment, or codes, which includes one or more executable instructions for implementing specified logical functions. It is also noted that, in some alternative implementations, the functions noted in the block may occur out of the order noted in the figures. For example, two blocks shown in succession may, in fact, be executed substantially in parallel, and may sometimes be executed in the reverse order, depending on the functions involved. It is also noted that each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The units involved in the embodiments described in the present disclosure may be implemented by software or hardware. The name of the unit does not constitute a limitation on the unit itself in some cases. For example, a first acquisition unit can also be described as “a unit that acquires at least two Internet protocol addresses”.

The functions described above herein may be at least partially performed by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

In a first aspect, according to one or more embodiments of the present disclosure, a video processing method is provided and includes: determining a target image to be processed in a video; performing semantic segmentation on the target image through a convolutional neural network to obtain a first feature map, wherein the first feature map comprises a feature map corresponding to at least one semantic class; determining a target image region corresponding to the semantic class in the target image according to the first feature map; wherein the semantic class comprises an object-in-hand, and a training image adopted by the convolutional neural network in a training process is marked with an image region corresponding to the semantic class.

According to one or more embodiments of the present disclosure, a plurality of semantic classes are provided, and different semantic classes have contextual relations, the determining a target image region corresponding to the semantic class in the target image according to the first feature map, may include: determining the target image region according to a first sub-feature map and a plurality of second sub-feature maps: wherein the first sub-feature map is a feature map corresponding to an image background in the first feature map, the second sub-feature map is a feature map corresponding to the semantic class in the first feature map, and different second sub-feature maps correspond to different semantic classes.

According to one or more embodiments of the present disclosure, a pixel value in the second sub-feature map is a weight that a corresponding pixel in the target image belongs to a semantic class corresponding to the second sub-feature map, the determining the target image region according to a first sub-feature map and a plurality of second sub-feature maps, may include: for a plurality of pixels in the target image, determining a maximum value of the pixel among corresponding pixel values in the first sub-feature map and the second sub-feature map, if a feature map where the maximum value is located is the first sub-feature map, determining that the pixel belongs to the image background, otherwise, determining that the pixel belongs to a semantic class corresponding to the feature map where the maximum value is located; determining the target image region according to the semantic class to which the plurality of pixels belong.

According to one or more embodiments of the present disclosure, determining a target image region corresponding to the semantic class in the target image according to the first feature map, may include: acquiring a second feature map, wherein the second feature map is a feature map obtained by performing semantic segmentation on a reference image, and the reference image is an image located in front of the target image in the video and at least one frame apart; fusing the first feature map and the second feature map to obtain a fused feature map; determining the target image region according to the fused feature map.

According to one or more embodiments of the present disclosure, the fusing the first feature map and the second feature map to obtain a fused feature map, may include: fusing a feature map corresponding to an image background in the first feature map and a feature map corresponding to the image background in the second feature map to obtain a first fused sub-feature map; fusing a feature map corresponding to a semantic class in the first feature map with a feature map corresponding to a same semantic class in the second feature map to obtain a second fused sub-feature map.

According to one or more embodiments of the present disclosure, before fusing the first feature map and the second feature map to obtain a fused feature map, the method further includes: determining an optical flow between the target image and the reference image; adjusting the second feature map according to the optical flow.

According to one or more embodiments of the present disclosure, the determining a target image to be processed in a video, may include: determining the target image in the video according to a preset interval frame number.

According to one or more embodiments of the present disclosure, after determining a target image region corresponding to the semantic class in the target image according to the first feature map, the method further includes: generating a target box corresponding to the object-in-hand in the target image according to the target image region; tracking the object-in-hand appearing in the target image according to the target box.

According to one or more embodiments of the present disclosure, tracking the object-in-hand appearing in the target image according to the target box, may include: acquiring a tracking box, wherein the tracking box is from a previous image frame of the target image, different tracking boxes correspond to different object IDs, and the object ID is used for uniquely identifying the object-in-hand; matching the tracking box with the target box to obtain a matching result; updating the tracking box in the target image according to the matching result.

According to one or more embodiments of the present disclosure, updating the tracking box in the target image according to the matching result, may include: if a tracking box matching the target box exists, updating the tracking box matching the target box into the target box; if no tracking box matching the target box exists, determining that the target box is a new tracking box, and assigning the object ID to the new tracking box; if no target box matching the tracking box exists, deleting the tracking box.

According to one or more embodiments of the present disclosure, matching the tracking box with the target box to obtain a matching result, may include: determining an overlapping degree between the tracking box and the target box; determining a tracking box matched with the target box according to the overlapping degree.

According to one or more embodiments of the present disclosure, after determining a target image region corresponding to the semantic class in the target image according to the first feature map, the method further includes: if a target object leaving a hand appears in the video, tracking the target object based on an image region where the target object is located in the target image region.

According to one or more embodiments of the present disclosure, the performing semantic segmentation on the target image through a convolutional neural network to obtain a first feature map, may include: performing semantic segmentation on the target image and a preset number of images in the video located in front of the target image through the convolutional neural network to obtain the first feature map, wherein the preset number of images located in front of the target image are used for assisting the semantic segmentation of the target image.

In a second aspect, according to one or more embodiments of the present disclosure, a video processing device is provided and includes: a first determination unit, configured for determining a target image to be processed in a video; a segmentation unit, configured for performing semantic segmentation on the target image through a convolutional neural network to obtain a first feature map, wherein the first feature map comprises a feature map corresponding to at least one semantic class; a second determination unit, configured for determining a target image region corresponding to the semantic class in the target image according to the first feature map; wherein the semantic class comprises an object-in-hand, and a training image adopted by the convolutional neural network in a training process is marked with an image region corresponding to the semantic class.

According to one or more embodiments of the present disclosure, a plurality of semantic classes are provided, and different semantic classes have contextual relations, the second determination unit is further configured for: determining the target image region according to a first sub-feature map and a plurality of second sub-feature maps; wherein the first sub-feature map is a feature map corresponding to an image background in the first feature map, the second sub-feature map is a feature map corresponding to the semantic class in the first feature map, and different second sub-feature maps correspond to different semantic classes.

According to one or more embodiments of the present disclosure, a pixel value in the second sub-feature map is a weight that a corresponding pixel in the target image belongs to a semantic class corresponding to the second sub-feature map, the second determination unit is further configured for: for a plurality of pixels in the target image, determining a maximum value of the pixel among corresponding pixel values in the first sub-feature map and the second sub-feature map, if a feature map where the maximum value is located is the first sub-feature map, determining that the pixel belongs to the image background, otherwise, determining that the pixel belongs to a semantic class corresponding to the feature map where the maximum value is located: determining the target image region according to the semantic class to which the plurality of pixels belong.

According to one or more embodiments of the present disclosure, the second determination unit is further configured for: acquiring a second feature map, wherein the second feature map is a feature map obtained by performing semantic segmentation on a reference image, and the reference image is an image located in front of the target image in the video and at least one frame apart; fusing the first feature map and the second feature map to obtain a fused feature map; determining the target image region according to the fused feature map.

According to one or more embodiments of the present disclosure, the second determination unit is further configured for: fusing a feature map corresponding to an image background in the first feature map and a feature map corresponding to the image background in the second feature map to obtain a first fused sub-feature map; fusing a feature map corresponding to a semantic class in the first feature map with a feature map corresponding to a same semantic class in the second feature map to obtain a second fused sub-feature map.

According to one or more embodiments of the present disclosure, the second determination unit is further configured for: determining an optical flow between the target image and the reference image; adjusting the second feature map according to the optical flow.

According to one or more embodiments of the present disclosure, the first determination unit is further configured for: determining the target image in the video according to a preset interval frame number.

According to one or more embodiments of the present disclosure, the video processing apparatus further includes a first tracking unit, the first tracking unit is configured for: generating a target box corresponding to the object-in-hand in the target image according to the target image region: tracking the object-in-hand appearing in the target image according to the target box.

According to one or more embodiments of the present disclosure, the first tracking unit is configured for: acquiring a tracking box, wherein the tracking box is from a previous image frame of the target image, different tracking boxes correspond to different object IDs. and the object ID is used for uniquely identifying the object-in-hand; matching the tracking box with the target box to obtain a matching result; updating the tracking box in the target image according to the matching result.

According to one or more embodiments of the present disclosure, the first tracking unit is configured for: if a tracking box matching the target box exists, updating the tracking box matching the target box into the target box, if no tracking box matching the target box exists, determining that the target box is a new tracking box, and assigning the object ID to the new tracking box: if no target box matching the tracking box exists, deleting the tracking box.

According to one or more embodiments of the present disclosure, the first tracking unit is configured for: determining an overlapping degree between the tracking box and the target box; determining a tracking box matched with the target box according to the overlapping degree.

According to one or more embodiments of the present disclosure, the video processing apparatus further includes a second tracking unit, the second tracking unit is configured for: if a target object leaving a hand appears in the video, tracking the target object based on an image region where the target object is located in the target image region.

According to one or more embodiments of the present disclosure, the segmentation unit is further configured for: performing semantic segmentation on the target image and a preset number of images in the video located in front of the target image through the convolutional neural network to obtain the first feature map, wherein the preset number of images located in front of the target image are used for assisting the semantic segmentation of the target image.

In a third aspect, according to one or more embodiments of the present disclosure, an electronic device is provided. The electronic device includes: at least one processor and a memory;
the memory stores computer-executed instructions;
the at least one processor executes the computer-executed instructions stored in the memory, causing the at least one processor to execute the video processing method as described in the first aspect or various possible designs of the first aspect above.

In a fourth aspect, according to one or more embodiments of the present disclosure, a computer-readable storage medium is provided. The computer-readable storage medium with computer-executable instructions stored therein, which, when executed by a processor, realize the video processing method as described in the first aspect or various possible designs of the first aspect above.

In a fifth aspect, according to one or more embodiments of the present disclosure, a computer program product is provided. The computer program product includes computer-executed instructions which, when executed by a processor, realize the video processing method as described in the first aspect or various possible designs of the first aspect above.

In a sixth aspect, according to one or more embodiments of the present disclosure, a computer program is provided, when the computer program is executed by a processor, realizes the video processing method as described in the first aspect or various possible designs of the first aspect above.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. A video processing method, comprising:
determining a target image to be processed in a video;
performing semantic segmentation on the target image through a convolutional neural network to obtain a first feature map, wherein the first feature map comprises a feature map corresponding to at least one semantic class;
determining a target image region corresponding to the at least one semantic class in the target image according to the first feature map;
wherein the at least one semantic class comprises an object-in-hand, and a training image adopted by the convolutional neural network in a training process is marked with an image region corresponding to the at least one semantic class.

2. The video processing method according to claim 1, wherein a plurality of semantic classes are provided, and different semantic classes have contextual relations,
the determining a target image region corresponding to the at least one semantic class in the target image according to the first feature map, comprises:
determining the target image region according to a first sub-feature map and a plurality of second sub-feature maps;
wherein the first sub-feature map is a feature map corresponding to an image background in the first feature map, leach second sub-feature map in the plurality of second sub-feature maps is a feature map corresponding to a semantic class in the first feature map, and different second sub-feature maps correspond to different semantic classes.

3. The video processing method according to claim 2, wherein a pixel value in the second sub-feature map is a weight that a corresponding pixel in the target image belongs to the semantic class corresponding to the second sub-feature map,
the determining the target image region according to a first sub-feature map and a plurality of second sub-feature maps, comprises:
for each pixel in a plurality of pixels in the target image, determining a maximum value of the pixel among corresponding pixel values in the first sub-feature map and the plurality of second sub-feature map,
in response to a feature map where the maximum value is located being the first sub-feature map, determining that the pixel belongs to the image background,
in response to the feature map where the maximum value is located not being the first sub-feature map, determining that the pixel belongs to a semantic class corresponding to the feature map where the maximum value is located;
determining the target image region according to a semantic class to which each of the plurality of pixels belong.

4. The video processing method according to claim 1, wherein the determining a target image region corresponding to the at least one semantic class in the target image according to the first feature map, comprises:
acquiring a second feature map, wherein the second feature map is a feature map obtained by performing semantic segmentation on a reference image, and the reference image is an image located in front of the target image in the video and at least one frame apart;
fusing the first feature map and the second feature map to obtain a fused feature map;
determining the target image region according to the fused feature map.

5. The video processing method according to claim 4, wherein the fusing the first feature map and the second feature map to obtain a fused feature map, comprises:
fusing a feature map corresponding to an image background in the first feature map and a feature map corresponding to the image background in the second feature map to obtain a first fused sub-feature map;
fusing a feature map corresponding to a semantic class in the first feature map with a feature map corresponding to a same semantic class in the second feature map to obtain a second fused sub-feature map.

6. The video processing method according to claim 4, before fusing the first feature map and the second feature map to obtain a fused feature map, further comprising:
determining an optical flow between the target image and the reference image;
adjusting the second feature map according to the optical flow.

7. The video processing method according to claim 1, wherein the determining a target image to be processed in a video, comprises:
determining the target image in the video according to a preset interval frame number.

8. The video processing method according to claim 1, after determining a target image region corresponding to the at least one semantic class in the target image according to the first feature map, further comprising:
generating a target box corresponding to the object-in-hand in the target image according to the target image region;
tracking the object-in-hand appearing in the target image according to the target box.

9. The video processing method according to claim 8, wherein the tracking the object-in-hand appearing in the target image according to the target box, comprises:
acquiring a tracking box, wherein the tracking box is from a previous image frame of the target image, different tracking boxes correspond to different object IDs, and each object ID is used for uniquely identifying a corresponding object-in-hand;
matching the tracking box with the target box to obtain a matching result;
updating the tracking box in the target image according to the matching result.

10. The video processing method according to claim 9, wherein the updating the tracking box in the target image according to the matching result, comprises:
for each target box, in response to a first tracking box matching the target box, updating the first tracking box matching the target box into the target box;
in response to no tracking box matching the target box, determining that the target box is a new tracking box, and assigning an object ID to the new tracking box;
for any tracking box, in response to no target box matching the any tracking box, deleting the any tracking box.

11. The video processing method according to claim 9, wherein at least one object-in-hand appears in the video, and at least one tracking box and at least one target box are provided,
the matching the tracking box with the target box to obtain a matching result, comprises:
for each tracking box in the at least one tracking box and each target box in the at least one target box, determining an overlapping degree between the tracking box and the target box to obtain at least one overlapping degree;
for each target box, determining a tracking box matched with the target box according to the at least one overlapping degree.

12. The video processing method according to claim 1, after determining a target image region corresponding to the semantic class in the target image according to the first feature map, further comprising:
in response to a target object leaving a hand appearing in the video, tracking the target object based on an image region where the target object is located in the target image region.

13. The video processing method according to claim 1, wherein the performing semantic segmentation on the target image through a convolutional neural network to obtain a first feature map, comprises:
performing semantic segmentation on the target image and a preset number of images in the video located in front of the target image through the convolutional neural network to obtain the first feature map, wherein the preset number of images located in front of the target image are used for assisting the semantic segmentation of the target image.

14. A video processing device, comprising:
a first determination unit, configured for determining a target image to be processed in a video;
a segmentation unit, configured for performing semantic segmentation on the target image through a convolutional neural network to obtain a first feature map, wherein the first feature map comprises a feature map corresponding to at least one semantic class;
a second determination unit, configured for determining a target image region corresponding to the at least one semantic class in the target image according to the first feature map;
wherein the at least one semantic class comprises an object-in-hand, and a training image adopted by the convolutional neural network in a training process is marked with an image region corresponding to the at least one semantic class.

15. An electronic device comprising: at least one processor and a memory;
the memory stores computer-executed instructions;
the at least one processor executes the computer-executed instructions stored in the memory, causing the at least one processor to execute a video processing method,
wherein the video processing method comprises:
determining a target image to be processed in a video;
performing semantic segmentation on the target image through a convolutional neural network to obtain a first feature map, wherein the first feature map comprises a feature map corresponding to at least one semantic class;
determining a target image region corresponding to the at least one semantic class in the target image according to the first feature map;
wherein the at least one semantic class comprises an object-in-hand, and a training image adopted by the convolutional neural network in a training process is marked with an image region corresponding to the at least one semantic class.

16. A computer-readable storage medium with computer-executable instructions stored therein, which, when executed by a processor, realize the video processing method according to claim 1.

17-18. (canceled)

19. The electronic device according to claim 15, wherein a plurality of semantic classes are provided, and different semantic classes have contextual relations,
the at least one processor further causes the electronic device to:
determine the target image region according to a first sub-feature map and a plurality of second sub-feature maps;
wherein the first sub-feature map is a feature map corresponding to an image background in the first feature map, each second sub-feature map in the plurality of second sub-feature maps is a feature map corresponding to a semantic class in the first feature map, and different second sub-feature maps correspond to different semantic classes.

20. The electronic device according to claim 19, wherein a pixel value in the second sub-feature map is a weight that a corresponding pixel in the target image belongs to the semantic class corresponding to the second sub-feature map,
the at least one processor further causes the electronic device to:
for each pixel in a plurality of pixels in the target image, determine a maximum value of the pixel among corresponding pixel values in the first sub-feature map and the plurality of second sub-feature maps,
in response to a feature map where the maximum value is located being the first sub-feature map, determine that the pixel belongs to the image background,
in response to the feature map where the maximum value is located not being the first sub-feature map, determine that the pixel belongs to a semantic class corresponding to the feature map where the maximum value is located;
determine the target image region according to a semantic class to which each of the plurality of pixels belong.
